(19) United States
(12) Patent Application Publication
(10) Pub. No.: US 2024/0054676 A1
(43) Pub. Date: Feb. 15, 2024

(54) METHODS AND APPARATUS FOR DETERMINING ORIENTATIONS OF AN OBJECT IN THREE-DIMENSIONAL DATA

(71) Applicant: Cognex Corporation, Natick, MA (US)

(72) Inventors: Nitin M. Vaidya, Shrewsbury, MA (US); Nathaniel Bogan, Natick, MA (US)

(73) Assignee: Cognex Corporation, Natick, MA (US)

(21) Appl. No.: 18/448,824

(22) Filed: Aug. 11, 2023

Related U.S. Application Data
(60) Provisional application No. 63/397,568, filed on Aug. 12, 2022.

(51) Int. Cl. G06T 7/73; G06T 7/60

(52) U.S. Cl. CPC G06T 7/74; G06T 7/60; G06T 2207/10028

(57) ABSTRACT

The techniques described herein relate to methods, apparatus, and computer readable media configured to determining a candidate three-dimensional (3D) orientation of an object represented by a three-dimensional (3D) point cloud. The method includes receiving data indicative of a 3D point cloud comprising a plurality of 3D points, determining a first histogram for the plurality of 3D points based on geometric features determined based on the plurality of 3D points, accessing data indicative of a second histogram of geometric features of a 3D representation of a reference object, computing, for each of a plurality of different rotations between the first histogram and the second histogram in 3D space, a scoring metric for the associated rotation, and determining the candidate 3D orientation based on the scoring metrics of the plurality of different rotations.

### RELATED APPLICATIONS

This application claims priority under 35 U.S.C. § 119(e) to U.S. Provisional Application Ser. No. 63/397,568, titled “METHODS AND APPARATUS FOR DETERMINING ORIENTATIONS OF AN OBJECT IN THREE-DIMENSIONAL DATA,” filed on Aug. 12, 2022, which is herein incorporated by reference in its entirety.

### TECHNICAL FIELD

The techniques described herein relate generally to methods and apparatus for machine vision, including techniques for determining a set of orientations, such as possible orientations, of an object in three-dimensional data.

### BACKGROUND OF INVENTION

Machine vision systems can include robust imaging capabilities, including three-dimensional (3D) imaging devices. For example, 3D sensors can image a scene to generate a set of 3D points that each include an (x, y, z) location within a 3D coordinate system (e.g., where the z axis of the coordinate system represents a distance from the 3D imaging device). Such 3D imaging devices can generate a 3D point cloud, which includes a set of 3D points captured during a 3D imaging process. However, the sheer number of 3D points in 3D point clouds can be massive (e.g., compared to 2D data of a scene). Additionally, 3D point clouds may only include pure 3D data points, and therefore may not include data indicative of relations between/among the 3D points, or other information, such as surface normal information. It can be complicated to process 3D points without data indicative of relations among other points. Therefore, while 3D point clouds can provide a large amount of 3D data, performing machine vision tasks on 3D point cloud data can be complicated, time consuming, require significant processing resources, and/or the like.

### SUMMARY OF INVENTION

In accordance with the disclosed subject matter, apparatus, systems, and methods are provided for improved machine vision techniques, and in particular for improved machine vision techniques that generate a set of candidate orientation(s) of an object in 3D data. The orientation can represent, for example, a tilt, tilt-direction and/or in-plane rotation of the object in the 3D data. The techniques can determine the set of candidate orientation(s) by generating histograms of geometrical features (e.g., surface normals, edge directions) of the 3D point of both a 3D reference image (e.g., of the reference object to search for in new images) and a runtime 3D image (e.g., of a scene where the object is expected to be located). The histograms can be compared to identify the set of candidate orientation(s). The set of candidate orientation(s) can be used to determine a full pose of the object in the runtime 3D image. For example, the set of candidate orientation(s) can be used to seed the search process for a higher-dimension pose of the object in the 3D image (e.g., a pose that includes both orientation and position). The pose can be, for example, a 6 degrees of freedom (6DoF) pose that includes a position (e.g., {x, y, z}) as well as an orientation (e.g., {tilt, tilt-direction, in-plane rotation}).

Some aspects relate to a computerized method for determining a candidate three-dimensional (3D) orientation of an object represented by a three-dimensional (3D) point cloud. The method includes receiving data indicative of a 3D point cloud comprising a plurality of 3D points, determining a first histogram for the plurality of 3D points based on geometric features determined based on the 3D points (e.g., a runtime histogram), accessing data indicative of a second histogram of geometric features of a 3D representation of a reference object (e.g., a reference histogram), computing, for each of a plurality of different rotations between the first histogram and the second histogram in 3D space (e.g., by rotating the second histogram with respect to the first histogram), a scoring metric for the associated rotation, and determining the candidate 3D orientation based on the scoring metrics of the plurality of different rotations.

According to some examples, the plurality of different rotations are of the second histogram in 3D space with respect to the first histogram; the plurality of different rotations are of the first histogram in 3D space with respect to the second histogram; or some combination thereof.

According to some examples, the scoring metric comprises data indicative of a measure of match of the first histogram with a rotated version of the second histogram.

According to some examples, the method further comprises performing each of the plurality of different rotations in three degrees of freedom space.

According to some examples, the method further comprises determining the geometric features based on the plurality of 3D points, comprising estimating the geometric features of a surface of the object represented by the plurality of 3D points.

According to some examples, the geometric features comprise surface normals of a surface of the object represented by the plurality of 3D points, edges of the surface, or both.

According to some examples, the method further comprises pre-determining the plurality of different rotations.

According to some examples, the method further comprises pre-determining, for each of the plurality of different rotations, correspondences between bins of the first histogram and bins of the second histogram.

According to some examples, the method further comprises caching only the pre-determined correspondences for bins of the second histogram that comprise a value greater than a predetermined threshold.

According to some examples, the method further comprises determining a set of the plurality of different rotations with associated scoring metrics that form a local maximum; and determining the candidate 3D orientation based on the local maximum.

According to some examples, the method further comprises refining, using interpolation, the candidate 3D orientation based on the local maximum to generate a refined candidate 3D orientation.

According to some examples, refining, using the interpolation, comprises fitting an elliptical paraboloid to scoring metrics of rotations of the plurality of different rotations that neighbor the local maximum.

According to some examples, the refined candidate 3D orientation comprises an orientation and a scoring metric of a peak of the fitted elliptical paraboloid.

Some aspects relate to a computerized method for determining a six degrees-of-freedom (6DoF) pose of an object represented by three-dimensional (3D) data. The method includes receiving data indicative of 3D data comprising a plurality of 3D points; determining a first histogram for the plurality of 3D points based on geometric features determined based on the plurality of 3D points; accessing data indicative of a second histogram of geometric features of a 3D representation of a reference object; computing, based on the first histogram and the second histogram, a set of possible orientations of the object represented by the 3D data; computing, based on the set of possible orientations, (1) a location of the object represented by the 3D data and (2) a final orientation; and determining a pose of the object comprising the location and the final orientation.

According to some examples, computing, based on the first histogram and the second histogram, the set of possible orientations of the object represented by the 3D data comprises: computing, for each of a plurality of different rotations between the first histogram and the second histogram in 3D space, a scoring metric for the associated rotation; and determining the set of possible orientations based on the scoring metrics of the plurality of different rotations.

According to some examples, the method further comprises determining a set of the plurality of different rotations with associated scoring metrics that form a local maximum; and determining a candidate of the final orientation based on the local maximum.

According to some examples, the method further comprises refining, using interpolation, the candidate of the final orientation based on the local maximum to generate a refined candidate of the final orientation.

According to some examples, refining, using the interpolation, comprises fitting an elliptical paraboloid to scoring metrics of rotations of the plurality of different rotations that neighbor the local maximum.

According to some examples, the refined candidate of the final orientation comprises an orientation and a scoring metric of a peak of the fitted elliptical paraboloid.

According to some examples, the plurality of different rotations are of the second histogram in 3D space with respect to the first histogram; the plurality of different rotations are of the first histogram in 3D space with respect to the second histogram; or some combination thereof.

According to some examples, the scoring metric comprises data indicative of a measure of match of the first histogram with a rotated version of the second histogram.

According to some examples, the method further comprises performing each of the plurality of different rotations in three degrees of freedom space.

According to some examples, the method further comprises determining the geometric features based on the plurality of 3D points, comprising estimating the geometric features of a surface of the object represented by the plurality of 3D points.

According to some examples, the geometric features comprise surface normals of a surface of the object represented by the plurality of 3D points, edges of the surface, or both.

According to some examples, the method further comprises pre-determining the plurality of different rotations.

According to some examples, the method further comprises pre-determining, for each of the plurality of different rotations, correspondences between bins of the first histogram and bins of the second histogram.

According to some examples, the method further comprises caching only the pre-determined correspondences for bins of the second histogram that comprise a value greater than a predetermined threshold.

According to some examples, the final orientation is from the set of possible orientations and/or within a range of the set of possible orientations.

According to some examples, determining the pose of the object comprising the location and the final orientation comprises removing pose candidates with an orientation that has an angular distance greater than a threshold from the set of possible orientations.

Some aspects relate to a non-transitory computer-readable media comprising instructions that, when executed by one or more processors on a computing device, are operable to cause the one or more processors to execute the method of any of the techniques described herein.

Some aspects relate to a system comprising a memory storing instructions, and a processor configured to execute the instructions to perform the method of any of the techniques described herein.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1A is a diagram showing an exemplary machine vision system, according to some embodiments.

FIG. 1B shows an illustrative implementation of a computing device that may be used in connection with any of the embodiments of the techniques provided herein.

FIG. 2 is a flowchart of an exemplary computerized method for determining a candidate 3D orientation of an object in 3D data, according to some embodiments.

FIG. 3 is a diagram showing an example of a 3D point cloud, according to some embodiments.

FIG. 4 is a diagram showing an example of generating a histogram of directional features of 3D data, according to some embodiments.

FIG. 5 is a diagram showing exemplary point clouds and associated histograms, according to some embodiments.

FIG. 6 is a flowchart of an exemplary computerized method for determining a pose of an object in 3D data based on a set of possible orientations of an object in 3D data, according to some embodiments.

FIG. 7 is a diagram of an exemplary portion of a machine vision process, according to some embodiments.

### DETAILED DESCRIPTION OF INVENTION

The techniques described herein can be used to analyze 3D point cloud images. 3D point clouds provide popular representations of object surfaces under inspection using 3D point positions. However, 3D point clouds often include hundreds of thousands or millions of (x, y, z) points. Therefore, the inventors have appreciated that directly interpreting such a massive number of 3D points in space can therefore be quite time consuming and resource intensive. For example, since 3D point clouds include such massive numbers of 3D points and typically do not include information about structural or spatial relationships among the 3D points, trying to interpret a pure 3D point cloud can be infeasible for many machine vision applications, which may have limited time to perform such interpretations, limited hardware resources, and/or the like.

The inventors have developed technological improvements to machine vision techniques to address these and other inefficiencies. The techniques described herein can leverage directional-based histograms to score different relations (e.g., orientations) between the histograms to determine candidate orientation(s) of an object in a runtime 3D image of an object (e.g., where the object has an unknown pose and/or orientation in the scene). Such candidate orientation(s) can be leveraged to find a full pose of the object in the 3D image, such as a pose in full six degrees of freedom that includes both position (e.g., {x, y and z}) and orientation (e.g., {tilt, tilt-direction, and in-plane rotation}).

In the following description, numerous specific details are set forth regarding the systems and methods of the disclosed subject matter and the environment in which such systems and methods may operate, etc., in order to provide a thorough understanding of the disclosed subject matter. In addition, it will be understood that the examples provided below are exemplary, and that it is contemplated that there are other systems and methods that are within the scope of the disclosed subject matter.

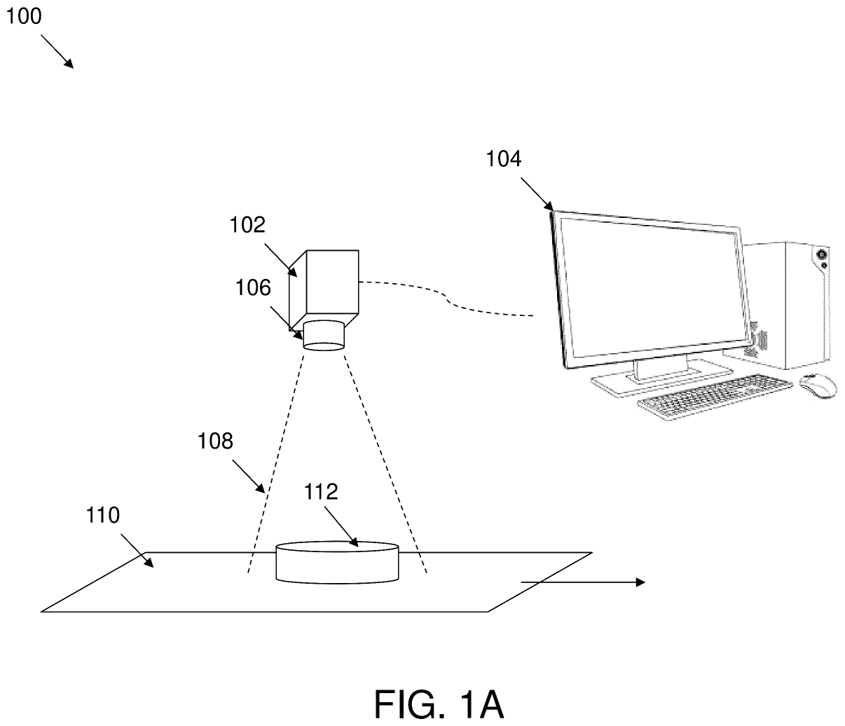

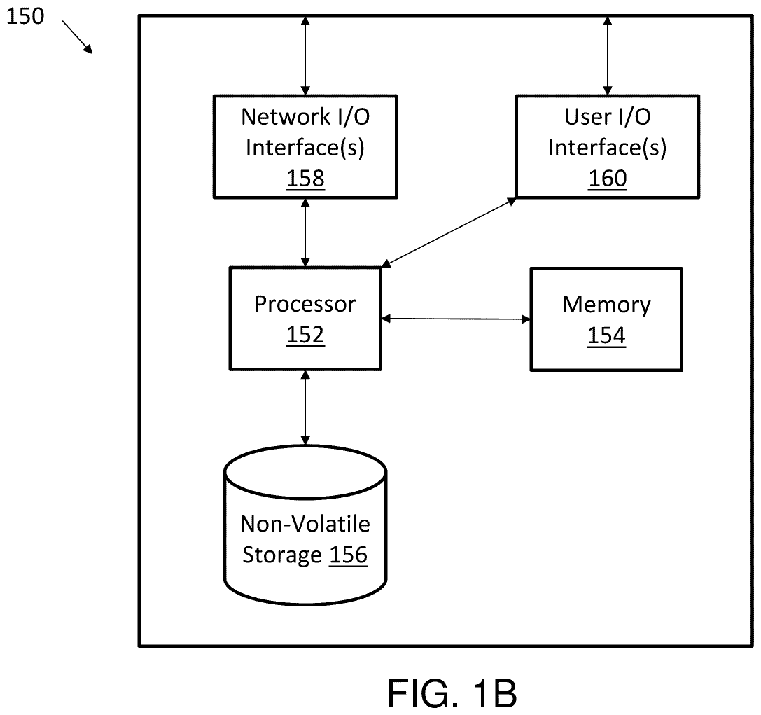

FIG. 1A shows an exemplary machine vision system 100, according to some embodiments. The exemplary machine vision system 100 includes a camera 102 (or other imaging acquisition device) and a computer 104. While only one camera 102 is shown in FIG. 1A, it should be appreciated that a plurality of cameras can be used in the machine vision system (e.g., where a point cloud is merged from that of multiple cameras). The computer 104 includes one or more processors and a human-machine interface in the form of a computer display and optionally one or more input devices (e.g., a keyboard, a mouse, a track ball, etc.). Camera 102 includes, among other components, a lens 106 and a camera sensor element (not illustrated). The lens 106 includes a field of view 108, and the lens 106 focuses light from the field of view 108 onto the sensor element. The sensor element generates a digital image of the camera field of view 108 and provides that image to a processor that forms part of computer 104. As shown in the example of FIG. 1A, object 112 travels along a conveyor 110 into the field of view 108 of the camera 102. The camera 102 can generate one or more digital images of the object 112 while it is in the field of view 108 for processing, as discussed further herein. In operation, the conveyor can contain a plurality of objects. These objects can pass, in turn, within the field of view 108 of the camera 102, such as during an inspection process. As such, the camera 102 can acquire at least one image of each observed object 112. Notably, in some embodiments, the machine vision system 100 may not include a conveyor. For example, the object 112 may be stationary (e.g., with a moving camera 102). As another example, the object 112 can be moved using other transfer devices, such as a robotic arm, a chute or slide (e.g., where gravity moves the object along the slide), and/or the like.

An illustrative implementation of a computing device 150 that may be used in connection with any of the embodiments of the disclosure provided herein is shown in FIG. 1B. For example, the computing device 150 can be used for the computer 104 in FIG. 1A. The computing device 150 may include one or more computer hardware processors 152 and one or more articles of manufacture that comprise non-transitory computer-readable storage media (e.g., memory 154 and one or more non-volatile storage devices 156). The processor 152(s) may control writing data to and reading data from the memory 154 and the non-volatile storage device(s) 156 in any suitable manner. The memory 154 can be, for example, a random access memory (RAM), a read-only memory (ROM), and/or the like. The non-volatile storage 156 can include, but is not limited to, a hard disk drive, a flash drive, a tape drive, an optical drive, a RAID array, and/or the like. To perform any of the functionality described herein, the processor(s) 152 may execute one or more processor-executable instructions stored in one or more non-transitory computer-readable storage media (e.g., the memory 154), which may serve as non-transitory computer-readable storage media storing processor-executable instructions for execution by the processor(s) 152. The computing device 150 may include various input/output (I/O) interfaces to interface with external systems and/or devices, including network I/O interface(s) 158 and user I/O interface(s) 160.

The computing device 150 can be any type of computing device with a processor 152, memory 154, and non-volatile storage device 156. For example, the computing device 150 can be a server, a desktop computer, a laptop, a tablet, or a smartphone. In some embodiments, the computing device 150 can be implemented using a plurality of computing devices, such as a cluster of computing devices, virtual computing devices, and/or cloud computing devices. Thus, examples of computer 104 in FIG. 1A can include, but are not limited to, a single server computer, a series of server computers, a single personal computer, a series of personal computers, a mini computer, a mainframe computer, one or more virtual computing devices and/or a computing cloud (or portions thereof). The various components of computing device 150 in FIG. 1B can execute one or more operating systems, examples of which can include but are not limited to: Microsoft Windows 11™, Microsoft Windows Server™; Novell Netware™; Yocto Linux™, Redhat Linux™, Unix, and/or a custom operating system, for example. The one or more computer hardware processors 152 of the computing device 150 can be configured to process operations stored in memory (memory 154 and/or non-volatile storage 156) accordingly to implement the one or more operating systems.

It should be appreciated that other components of the machine vision system can include components like those shown in FIG. 1B. For example, the camera 102 can include a network I/O interface, a processor, a user I/O interface, memory and/or non-volatile storage. In some embodiments, the techniques described herein can be performed using one or more of the camera 102 and/or the computing device 104 (e.g., which may or may not include using remote computing resources, such as virtual and/or cloud computing resources). Further, it should be appreciated that the aspects shown in FIG. 1A are not intended to be limiting, and that various machine vision system configurations can be used according to the techniques described herein. For example, aspects of the techniques described herein may be implemented using one or more computing devices or resources that may or may not be in communication with a camera. As an illustrative example, 3D data can be processed by a computing device according to the techniques described herein that is not connected to a camera. Accordingly, when examples described herein refer to the machine vision system, it should be appreciated that the machine vision system can be any type of computing device that may (or may not) be in communication with a camera.

In some embodiments, the camera 102 is a three-dimensional (3D) imaging device. As an example, the camera 102 can be a 3D sensor that scans a scene line-by-line, such as the Cognex DS-1000 line of laser profiler 3D displacement sensors, the Cognex 3D-L4000 line of 3D displacement sensors, and the Cognex 3D-A1000 and Cognex 3D-A5000 line of snapshot 3D sensors that capture point clouds, all of which are available from Cognex Corp., the assignee of the present application. According to some embodiments, the 3D imaging device can generate a set of (x, y, z) points (e.g., where the z axis adds a third dimension, such as a distance from the 3D imaging device). The 3D imaging device can use various 3D image generation techniques, such as shape-from-shading, stereo imaging, time of flight techniques, projector-based techniques, and/or other 3D generation technologies. In some embodiments, the machine vision system 100 includes a two-dimensional imaging device, such as a two-dimensional (2D) CCD or CMOS imaging array. In some embodiments, two-dimensional imaging devices generate a 2D array of brightness values.

In some embodiments, the machine vision system processes the data from the camera 102. For example, the machine vision system can receive 2D data from the camera and process the 2D data (e.g., from a 2D camera) to create 3D data, such as a point cloud and/or a range image. As another example, the data received from the camera 102 can include, for example, 3D data. A point cloud can include a group of 3D points that are on or near the surface of an object. For example, the points may be presented in terms of their coordinates in a rectilinear or other coordinate system. In some embodiments, other information, such as a mesh or grid structure indicating which points are neighbors on the object's surface, may optionally also be present. In some embodiments, information about surface features including curvatures, surface normals, edges, portions of edges (e.g., represented as a vector to indicate a direction of an edge) and/or color and albedo information, either derived from sensor measurements or computed previously, may be included in the input point clouds and/or determined using the input point clouds. In some embodiments, the 2D and/or 3D data may be obtained from a 2D and/or 3D sensor, from a CAD or other solid model, and/or by preprocessing range images, 2D images, and/or other images. It should be appreciated that there are many representations for 3D data (e.g., such as point clouds, range images, etc.) and that various techniques can be used to facilitate conversion from one representation to another representation. Accordingly, it should be appreciated that the discussion of point cloud herein does not limit the techniques to any particular 3D and/or point cloud format, but rather the techniques described herein can be used with any representation of 3D data.

According to some embodiments, the group of 3D points can be a portion of a 3D point cloud within user specified regions of interest and/or include data specifying the region of interest in the 3D point cloud. For example, since a 3D point cloud can include so many points, it can be desirable to specify and/or define one or more regions of interest (e.g., to limit the space to which the techniques described herein are applied).

Some machine vision tasks require identifying poses of objects in 3D images, such as in point clouds. Such an overall task can be performed by executing, for example, a pattern matching process. An example of a pattern matching process can include searching for a reference object in a runtime 3D image to determine the pose of a runtime object. However, the inventors have appreciated the difficulties of such pattern matching processes, particularly when performed in 3D. When searching for a pattern in a 3D image, the 3D image itself may simply be a 3D point cloud that just includes 3D points and no additional information (e.g., no information on surfaces, surface normals, edges, edge directions, etc.). As a result, the 3D image may first need to be processed to determine such information. Further, the object needs to be searched for in many different poses, where the poses can differ in up to six dimensions (e.g., three degrees of freedom (DoF) for a position and three DoF for orientation). As a result, searching for an object in a 3D image using a reference object can require testing large numbers of values for all dimensions of possible movement, which can be an extremely computationally-expensive process.

The inventors have appreciated that determining candidate orientation(s) of a (known) reference object in a 3D image can significantly speed up processes used to determine the (full) pose of the object in the 3D image. In some embodiments, the techniques include generating histograms of the reference object (e.g., based on 3D data of the reference object) and of the 3D image (e.g., an image captured of an object in a scene having an unknown pose), which are used to identify one or more candidate 3D orientations of the reference object in the 3D image. The histograms can, for example, represent geometrical information, such as surface normals and/or edge directions computed from the 3D points. The histogram of the reference object can be iteratively compared with the histogram of the 3D image to identify best scoring orientations of the histograms (e.g., that can be indicative of a likely orientation of the reference object in the 3D image). Accordingly, the techniques described herein can analyze just the orientation (and not the position) of the reference object in the 3D image. The candidate orientation(s) can then be used to speed up full pose estimation processes, such as by leveraging the candidate orientation(s) to impose bounds on the full poses that are tested in the 3D image to find the pose of the object in the 3D image.

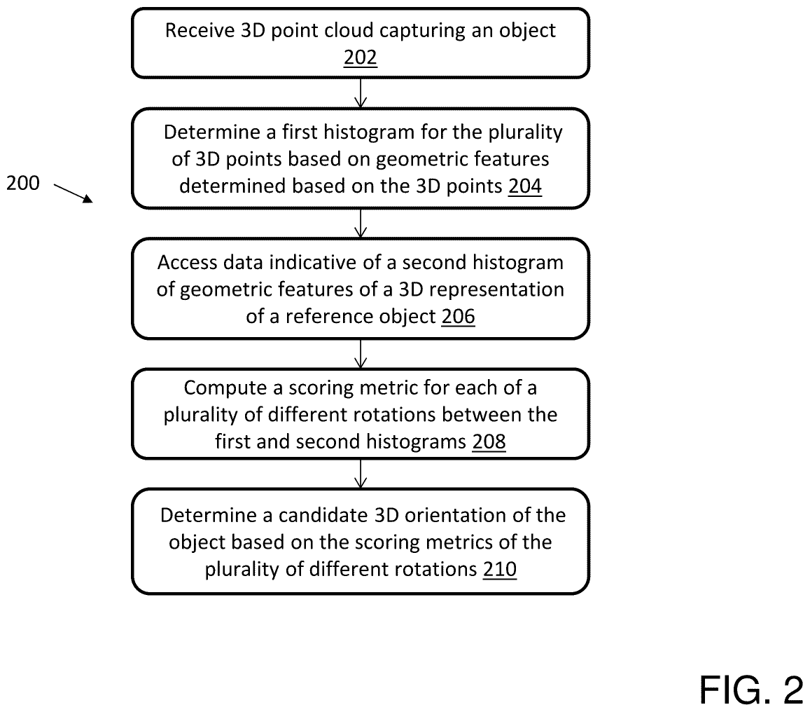

FIG. 2 is a flowchart of an exemplary computerized method 200 for determining a candidate three-dimensional (3D) orientation of an object represented by a three-dimensional (3D) point cloud, according to some embodiments. As described herein, the techniques may determine one or a plurality of candidate 3D orientations of the object. Generally, the techniques compare a first histogram with a second histogram to determine the candidate 3D orientations of the object represented by the 3D point cloud. In some embodiments, one of the first and second histograms can be of a reference object, which can be referred to as a reference histogram (e.g., since the reference histogram is used to search for the reference object in the 3D point cloud). The reference histogram can be generated based on reference data, such as captured and/or generated 3D data of the (known) reference object. The reference data can be referred to as a reference image. In some embodiments, the other of the first and second histograms can be generated based on the 3D point cloud that represents an object with an unknown pose and/or orientation, which can be referred to as a runtime histogram (e.g., since the orientation or pose of the object in the 3D point cloud is not yet known). The 3D point cloud that represents the object can be referred to as a runtime image.

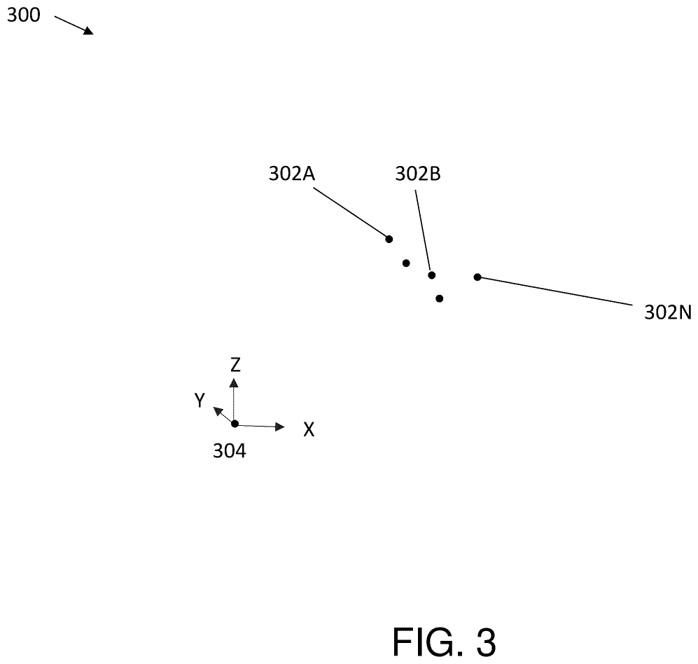

At step 202, the machine vision system (e.g., the machine vision system 100 of FIG. 1) receives a 3D point cloud that includes a plurality of 3D points. FIG. 3 is a diagram showing an example of a 3D point cloud 300, according to some embodiments. For illustrative purposes, the 3D point cloud 300 only shows a small number of 3D points 302A, 302B, through 302N, collectively referred to as 3D points 302. The 3D point cloud includes a point cloud coordinate system 304 with associated X, Y and Z axes. In some embodiments, the machine vision system captures imagery data and/or generates the 3D point cloud from the imagery data (e.g., which may be 2D and/or 3D data). In some embodiments, the machine vision system receives the 3D point cloud and/or generates the 3D point cloud based on data received from an external source (e.g., one or more cameras, a file, a data transmission from another computing device, etc.). As discussed herein, for example, the machine vision system may not include a camera and therefore the 3D point cloud can be provided from another source.

At step 204, the machine vision system determines a first histogram for the plurality of 3D points. The first histogram (e.g., the runtime histogram) can be determined based on geometric features that are computed using the 3D points. The geometric features can be determined to estimate one or more surfaces of the object represented by the 3D points. For example, the geometric features can include estimated directional information, such as surface normals of a surface of the object represented by the 3D points, edges of the surface (e.g., vectors indicative of a direction along an edge for an associated 3D point, line segments, etc.), and/or other geometric features. In some examples, the geometric features are provided as part of the data provided to the machine vision system (e.g., from the camera and/or a separate processing component). In some examples, the machine vision system computes the geometric features.

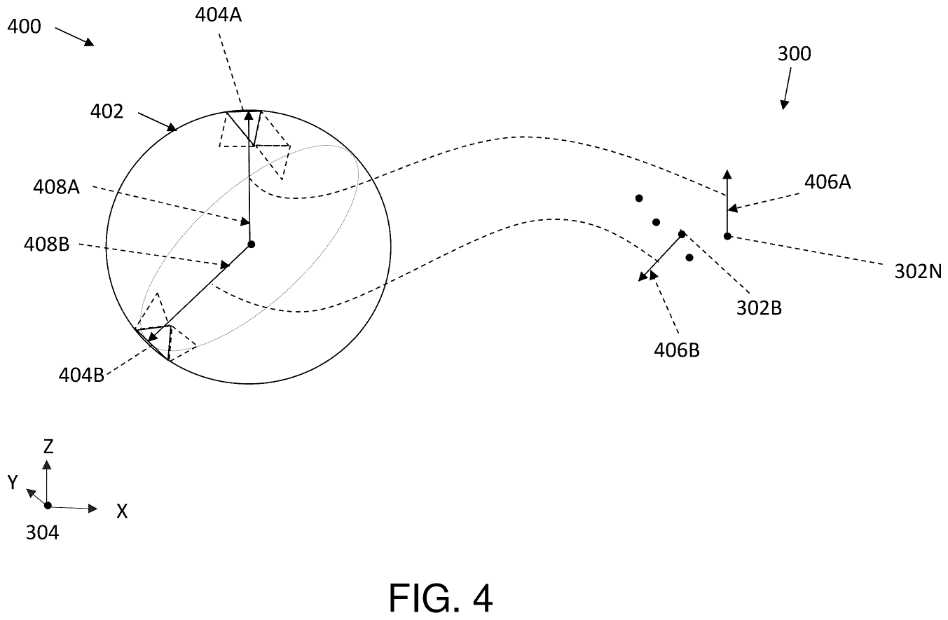

The first histogram can be generated based on directional geometric features of the 3D point cloud. Generally, the histogram can bin similar directional features. In some examples, the histogram can be visualized as a spherical histogram that represents the direction of the features (e.g., the latitude and longitude of the features), although it should be appreciated that this description is simply for illustrative purposes. FIG. 4 shows an example of a directional histogram 400, according to some embodiments. The bins of the histogram can be visualized as facets along the sphere 402, such as facets 404A and 404B (collectively referred to as facets 404), with additional facets shown in dashed lines to convey that the facets can extend across and cover the full range of possible directions of the directional geometric features. As shown in FIG. 4, the facets 404 represent a range of directional features such that the facets in this example are triangular when visualized on the surface of the sphere 402, but can be of any desirable size and/or shape to capture an associated range of the features. Thus, the bins can be visualized as a mesh of facets that approximate the surface of the sphere.

FIG. 4 shows the exemplary point cloud 300 from FIG. 3. The sphere 402 can be agnostic to a length of the geometric features, such as any length of the vector 406A associated with the 3D point 302N and of the vector 406B of point 302B (e.g., surface normal vectors, edge vectors, etc.). Directional information can be represented as a histogram using the sphere 402 to visualize such representation by determining histogram values for each facet based on the number of unit vectors that pierce the triangular facet associated with that pixel. For example, the histogram can sum the number of unit vectors that pierce each triangular facet. As a result, the histogram can be a histogram of directions of surface normals. This is illustrated in FIG. 4, where the sphere 402 can be viewed as a unit sphere that represents the directional features of the vectors 406A and 406B, as shown by the unit vectors 408A and 408B associated with vectors 406A and 406B, respectively. As shown in the example in FIG. 4, when positioned from the center of the sphere 402, the unit vector 408A falls within the facet 404A, and the unit vector 408B falls within the facet 404B. Thus, each vector contributes to the sum of the bin associated with the corresponding facet. Accordingly, in some examples the histogram can be a 2D histogram with bins that represent associated 1D, 2D and/or 3D ranges of directions. It should be appreciated that while only a few vectors are illustrated in FIG. 4, this is for illustrative purposes since there can be large numbers of vectors that are used to determine the associated histogram.

In some embodiments, the machine vision system receives the histograms (e.g., from the camera and/or from a separate computing device). In some embodiments, the machine vision system calculates the directional features and/or the histograms based on the directional features. In some embodiments, the machine vision system can receive and/or determine multiple histograms for a single point cloud. For example, the machine vision system can construct a first surface normal histogram of surface normals of the 3D points, and a first edge histogram of the directions of points along 3D edges. For ease of explanation without intending to be limiting, some examples described herein will refer to the first surface normal histogram of normals as R N and the first edge histogram of edge information as R E. Both of the first histograms R N and R E can be represented using the same number of facets that bin directions using the same range of directions associated with each facet (e.g., such that each of the first histograms R N and R E have a same number of n facets/bins).

At step 206, the machine vision system accesses data of a second histogram of geometric features of a 3D representation of a reference object. The second histogram (e.g., a reference histogram) can be generated based on any type of 3D data, such as a Computer-Aided Drawing (CAD) of the reference image, a 3D point cloud created of the reference image (e.g., determined from a CAD drawing, captured by a camera imaging the reference object, etc.). As described herein, the second histogram is used to search for candidate 3D orientations of the object in the 3D point cloud received at step 202. As described above for the first histogram, in some embodiments the machine vision system can receive and/or determine multiple second histograms for the object data. For example, the machine vision system can construct and/or access a second surface normal histogram of surface normals of the reference object data, and a second edge histogram of the directions of points along the reference object data. For ease of explanation without intending to be limiting, some examples described herein will refer to the second surface normal histogram of normals as T_{N} and the second edge histogram of edge information as T_{E}. Both of the second histograms T_{N} and T_{E} can be represented using the same number of facets that bin directions using the same range of directions associated with each facet (e.g., such that each of the second histograms T_{N} and T_{E} have a same number of n facets/bins). Likewise, each of the first histograms R N and R E can have a same number of n facets/bins as the second histograms T_{N} and T_{E}.

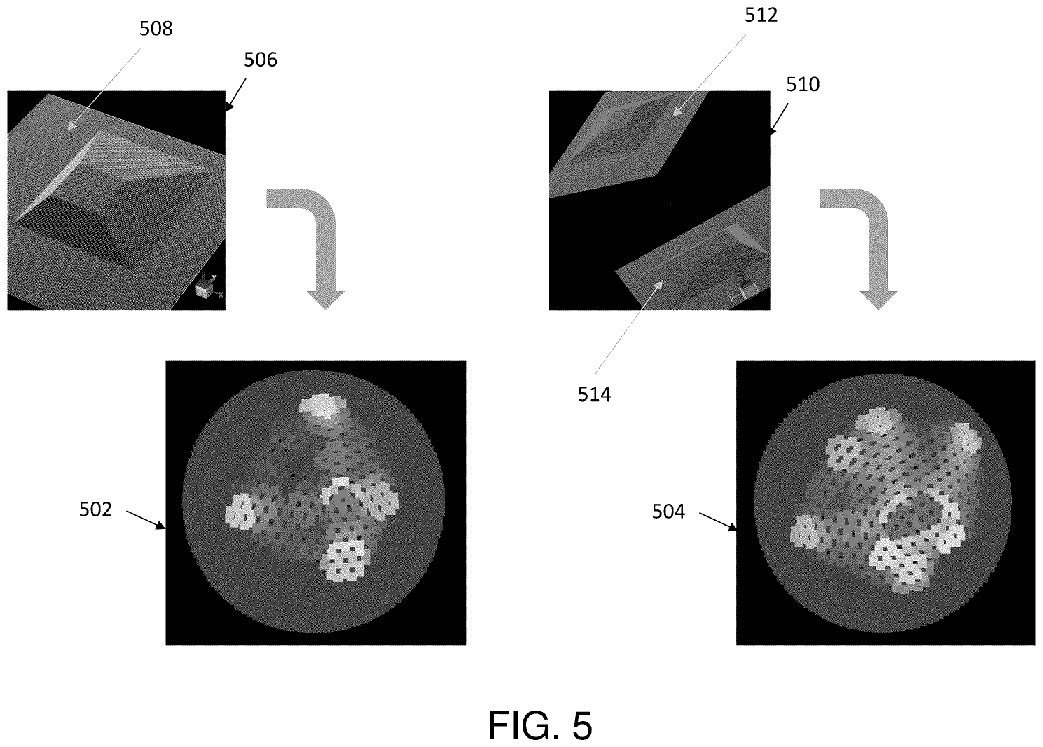

FIG. 5 shows visual examples of first and second histograms 502 and 504, according to some embodiments. The first histogram 502 (e.g., a runtime histogram) was generated based on the runtime data 3D data 506, which includes a single frustum 508. The second histogram 504 (e.g., a reference histogram) was generated based on the reference 3D data 510, which includes two frustums 512 and 514. As can be seen through the histograms 502 and 504, facets of the histogram with higher numbers of directional features falling in those facets are darker in shading compared to facets with fewer directional features. As a result, the histogram can be used as a “fingerprint” for the associated reference or runtime object. Thus, the first histogram can be searched for the second histogram to identify possible orientations of the reference object in the runtime 3D point cloud.

The machine vision system can search or scan the first histogram(s) for the second histogram(s) by scoring different comparisons (e.g., orientations) between the first and second histogram(s) to determine comparisons where the histogram data is similar. At step 208, the machine vision system computes, for each of a plurality of different rotations between the first histogram and the second histogram in 3D space, a scoring metric for the associated rotation. In some embodiments, the plurality of different rotations can be determined by rotating the second histogram (e.g., the reference histogram) with respect to the first histogram (e.g., the runtime histogram). However, the techniques are not so limited, and thus the different rotations can be of the first histogram with respect to the second histogram and/or a combination of rotations of the first and second histograms.

As discussed herein, when the histogram is viewed as a spherical histogram, conceptually such rotation is a rotation of the second histogram in 3D space with respect to the first histogram. However, since the histograms represent bins of associated ranges of the directional features, such rotations can be performed mathematically on the underlying histogram data. Therefore, it should be appreciated that the rotations described herein need not be actual 2D or 3D rotations of data in a 2D or 3D space, but rather can be mathematical operations performed to rotate and/or compare the histograms. For example, as explained herein, conceptually the bins cover the surface of a sphere in the sense that each bin includes a range of vector values that can be represented as an associated facet on the sphere. Aspects of the bin, such as the location of the associated facet specified by the facet's surface normal, can be mathematically processed to rotate the histogram from a first orientation (e.g., that of the original orientation of the histogram when it is created) to a second orientation. In some embodiments, for example, a rotation matrix (e.g., a 3×3 matrix that describes the rotation of a sphere) can be generated that specifies how to rotate the facets/bins from the first orientation to a second orientation (e.g., by multiplying the 3×1 vector of the surface normal of each bin/facet by the 3×3 rotation matrix).

In some embodiments, the rotations can be representative of different rotations in three degrees of freedom space. For example, since the directional histograms represent directional features (and thus, may not represent positional information), the rotations can be along the three degrees of one or more of tilt, tilt-direction, and/or in-plane rotation. As another example, the three degrees of rotation can be those of one or more of yaw, pitch and roll. Thus, such rotations can be about positional axes of the coordinate system, such as about the x, y and z axes.

In some embodiments, the techniques can be configured to systematically rotate the histogram(s) across the three-degrees-of-freedom space of all feasible rotations. As described herein, at each displacement, the machine visions system can calculate a score that represents the strength of the alignment between the two histograms at the rotation. Aspects of the facets can be used to determine the rotations of the histograms, such as geometric features of the facets, angular displacements between the facets, and/or the like. Referring to FIG. 4, for example, the facets each have an associated (e.g., unique) location along the surface of the sphere 402. Each facet can have a geometrical feature associated with the facet. For example, each facet can be associated with its own surface normal (e.g., which is separate and distinct from the vectors of the point cloud that are associated with the facet). As another example, the surface normals of adjacent facets can be separated by an angular distance.

The geometric features of the facets, such as surface normals of the facets and distances between facets, can be used to systematically step through the various possible rotations between the histograms. In some embodiments, the rotations can be achieved by a multi-step or loop process. For example, a first loop can rotate a particular facet of one histogram (e.g., the reference histogram) across all n facets of the other histogram (e.g., the runtime histogram). The particular facet of the first histogram can be selected for use for rotation according to various techniques. For example, the facet may be selected with an associated surface normal that is closest to a particular axis (e.g., the north pole, or z-axis, of the histogram). The first loop, or first series of steps, can rotate the second histograms, including T_{N} and T_{E} respectively, such that the facet with a surface normal closest to the north pole get positioned, in succession, atop all of the facets of the first histograms R N and R E. Conceptually, these rotations can be viewed as tilting the reference object to the represented object in the 3D data. In some examples, when the particular facet is rotated to match exactly the facets of the first histograms, then the maximum number of iterations possible for the first loop is equal to n, the number of facts in the spherical image. However, the techniques are not so limited. For example, the facets can be rotated in partial-facet steps. In some embodiments, the set of tested rotations in the first loop can be limited. For example, only a set of possible rotations may be scored. As an example, the environment may dictate a limit on the possible rotations that are tested (e.g., such as where the object being detected travels along a conveyor belt). As another example, a user may pre-configure the range of tilts that are tested by the machine vision system.

A second loop, or second series of steps, can iterate through a series of rotations for each individual rotation of the first step. For example, the series of rotations of the second loop can be based on the angular distance between neighboring facets (e.g., between the surface normals of neighboring facts). For an example of this loop, let T_{N}^{*} and T_{E}^{*} represent the second histograms at a particular rotation of the first loop where the particular facet is rotated to a matching facet f of the first histograms R N and R E. The second loop can include a stepwise rotation of the second histograms T_{N}^{*} and T_{E}^{*} about the axis defined by the normal of facet f. The step size of the rotations can be, for example, the mean angular spacing q between the surface normals of neighboring facets of the spherical image. The number of iterations in the middle loop can therefore, in some examples, be equal to 360 degrees divided by q.

A third step is to compute the score for each rotation achieved by each combination of the first and second steps. As an example, after each combination of iterations of the first and second loops, an associated rotational displacement of the reference spherical images can be represented by T_{N}^{**} and T_{E}^{**}. The third step can compute a measure of the match of the alignment of the spherical images, such as an alignment score for this particular displacement. The score can be computed based on the facets of the histograms. As an illustrative example, the score can involve computations (e.g., summations) across facets of the rotated second histogram and the first histogram (e.g., summations across all n facets of the histogram). For example, the score can sum, for each aligned facet of the second histogram and the first histogram at the particular orientation, a metric determined based on the values of the aligned facets. For example, the metric can be the minimum value of the two aligned facets, such that the score involves the summation across the facet pairs of the minimum value of each facet pair.

An illustrative example of one possible scoring technique is shown in Equation 1:

Score=Σ_{i=1 to n}(min{T_{N}^{**}[i],R_{N}[i]}+min{T_{E}^{**}[i],R_{E}[i]}) Equation 1

### Where:

The first histograms (e.g., runtime histograms) are represented by R_{N} and R_{E};
The displaced second histograms (e.g., reference histograms) for the normals and edges are represented by T_{N}^{**} and T_{E}^{**}; and
Variable i represents a particular pair of aligned facets, ranging from 1 to the total number of facets n.

As shown in Equation 1, the computed score involves comparing the values of the facets of the first histogram with the values of the corresponding facets of the displaced second histograms. The contribution of a given facet is therefore the minimum (min) of the values of corresponding facet pairs. As shown in Equation 1 above, in fact, two pairs of corresponding values contribute to the score—one from the surface normal histograms and another from the edge direction histograms. While, in practice, Equation 1 has been demonstrated to be a sufficient scoring metric, it should be appreciated that variants and/or other scoring techniques can be used without departing from the spirit of the techniques described herein.

In some embodiments, data used for the scanning process can be cached by the machine vision system. Memory of various component(s) of the machine vision system can be used to cache the data, such as memory of the camera 102 and/or the computing device 104 (e.g., a local computing device and/or a cloud computing device, as described herein). For example, aspects of the rotations of the first and/or second steps can be pre-determined and cached as part of the process. In some examples, for each rotation, the cached information can include correspondences between facets/bins of the first histogram and facets/bins of the second histogram. In some embodiments, the cached information can include information for bins of the second histogram that comprise a value greater than a predetermined threshold (e.g., greater than zero). In some embodiments, the outer and middle loops can be pre-run prior to use with the first histograms. Prior to running the scanning process, the pixel correspondences that are the outcomes of the rotational displacements of the second histograms by the combination of outer and middle loops can be cached. As a result, essentially half of the information for the scanning process can be pre-cached by the machine vision system for use with the first histogram information. Further, the amount of data that can be cached is a manageable amount, as the correspondences of only those facets of the second histogram can be stored that have non-zero value.

In some embodiments, only a subset of the facets of the second histograms can be used for the scanning and/or scoring processes. Such subsets can, in some embodiments, be used as probes, or points of particular interest. The subsets can, for example, be determined by selecting only facets with a histogram value that is above a probe threshold. The threshold used to select probes can be set according to various parameters. For example, in some embodiments, the threshold can be set to a conservative value, e.g., to ensure that a large fraction of the “energy” of the histogram is contained in the selected subset. In some embodiments, the probe threshold can be determined adaptively based on the histogram data. For example, the machine vision system can determine the sum of squared values of the histogram bins, sort those values in decreasing order, determine the cumulative sum of the sorted values to determine when the sum reaches a fraction of the total sum of squares (e.g., 70%, 80%, 90%, etc.), and use that corresponding un-squared bin value as the threshold value.

Additionally, or alternatively, the probes can be selected so that they are spaced from each other. As an illustrative example, the facets can be grouped into larger non-overlapping groups that are used to identify the ultimate facets to use for probes. For example, a highest-valued facet in each group can be identified, and analyzed for use as a probe. For example, the highest-value facet may only be selected for use as a probe if its value exceeds the threshold, otherwise none of the facets of the associated group are used for probes. Probes can be used in conjunction with other techniques described herein, such as in conjunction with caching. For example, probes can be used to reduce the number of correspondences that are generated and stored in cache for use during runtime. Further, such probes can speed-up execution of the scoring process.

At step 210, the machine vision system determines one or more candidate 3D orientations based on the scoring metrics of the plurality of different rotations. The result of the scanning and scoring process discussed in conjunction with step 208 can be a set of orientations and associated scores above a threshold. For example, the result can conceptually be a set of ordered-pairs of type {Rotational-displacement, Score} arrayed across the space of feasible rotations. In some embodiments, the machine vision system can identify those Rotational-displacements which are a local maxima with respect to score. Sorting these local maxima by score, the machine vision system can obtain a ranked list of candidate rotations to align the reference object to the orientation of instances in the runtime point cloud.

In some embodiments, the candidate rotations (e.g., the ranked list of candidate rotations) can be refined to determine a final set of candidate rotations of the object in the point cloud data. For example, since the identified candidate rotation(s) are determined at the granularity of facets/bins of the histogram, such candidate rotations may limit how close to actual ground truth the candidate orientation(s) (e.g., as determined via the local maxima approach) can reach. The precision of the candidate rotations can be improved by applying interpolation to refine the candidate rotations. In some embodiments, the machine vision system can identify the rotations that are in a neighborhood of any given local maximum. The system can fit an elliptical paraboloid to the score values (e.g., as determined at step 208) of the identified set of neighboring rotations. The location at which the fitted elliptical paraboloid attains a maximum can represent a refined value of the rotation of interest. Therefore, at step 210 the candidate 3D orientations can be identified as those refined though interpolation.

The candidate 3D orientations determined according to the techniques described herein can be used as part of, or in conjunction with, various machine vision tasks. For example, the 3D orientations can be used as part of an overall process to determine a pose in 3D space of an imaged object, such as a full 6DoF pose (including both position and rotation). Determining the pose of an object can be useful for myriad machine vision tasks, such as for part inspection (e.g., for damage detection, estimation of machined surface features, presence/absence of widget, etc.), part assembly, pick-and-place applications, and/or the like.

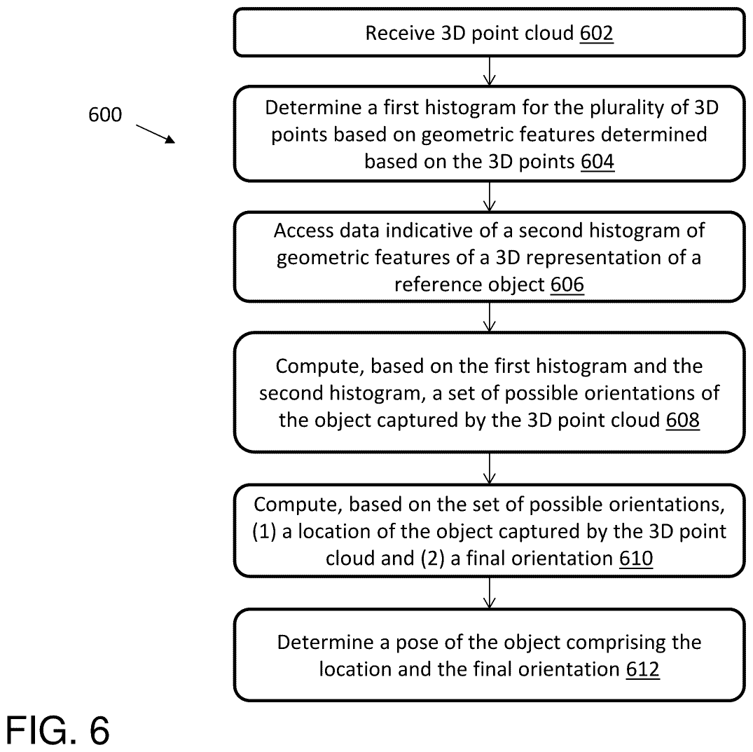

FIG. 6 is a flow chart of an exemplary computerized method for determining candidate 3D orientations and using the candidate 3D orientations to determine a pose (e.g., a 6 DoF pose) of an object, according to some embodiments. At step 602, the machine vision system (e.g., the machine vision system 100 of FIG. 1) receives a 3D point cloud that includes 3D points for an object (e.g., as described in conjunction with step 202 of FIG. 2). At steps 604-608, the machine vision system computes a set of possible orientations of the object. At step 604, the machine vision system determines a first histogram (e.g., a runtime histogram) for the plurality of 3D points based on geometric features determined based on the 3D points (e.g., as described in conjunction with step 204 of FIG. 2). At step 606, the machine vision system accesses data indicative of a second histogram (e.g., a reference histogram) of geometric features of a 3D representation of a reference object (e.g., as described in conjunction with steps 206 of FIG. 2). At step 608, the machine vision system computes, based on the first histogram and the second histogram, a set of possible orientations of the object represented by the 3D point cloud (e.g., a set of {tilt, tilt-direction, in-plane rotation} values with and/or without an associated score). The set of possible rotations can be determined as described, for example, in conjunction with steps 208-210 of FIG. 2.

At steps 610-612, the machine vision system uses the set of possible orientations to determine a pose of the object in the 3D point cloud. At step 610, the machine vision system computes, based on the set of possible orientations, (1) a location of the object represented by the 3D point cloud (e.g., an {x, y, z} location) and (2) a final orientation (e.g., {tilt, tilt-direction, and in-plane rotation}). At step 612, the machine vision system determines a pose of the object comprising the location and the final orientation (e.g., which may or may not be the same as any of the possible orientations from step 206).

In some embodiments, the 3DoF orientation candidate results can be used to speed-up a search for a full 6DoF pose of an object. For example, some 6DoF techniques can search for a 3DoF location in conjunction with searching for one or more degrees of a 3DoF orientation. Such a technique can be computationally expensive since it typically requires searching all (possible) instances of each value for each degree of freedom. As a result, if one or more of the unknown degrees can be limited by using the candidate 3DoF orientations, it can significantly speed up the search for a full 6DoF pose.

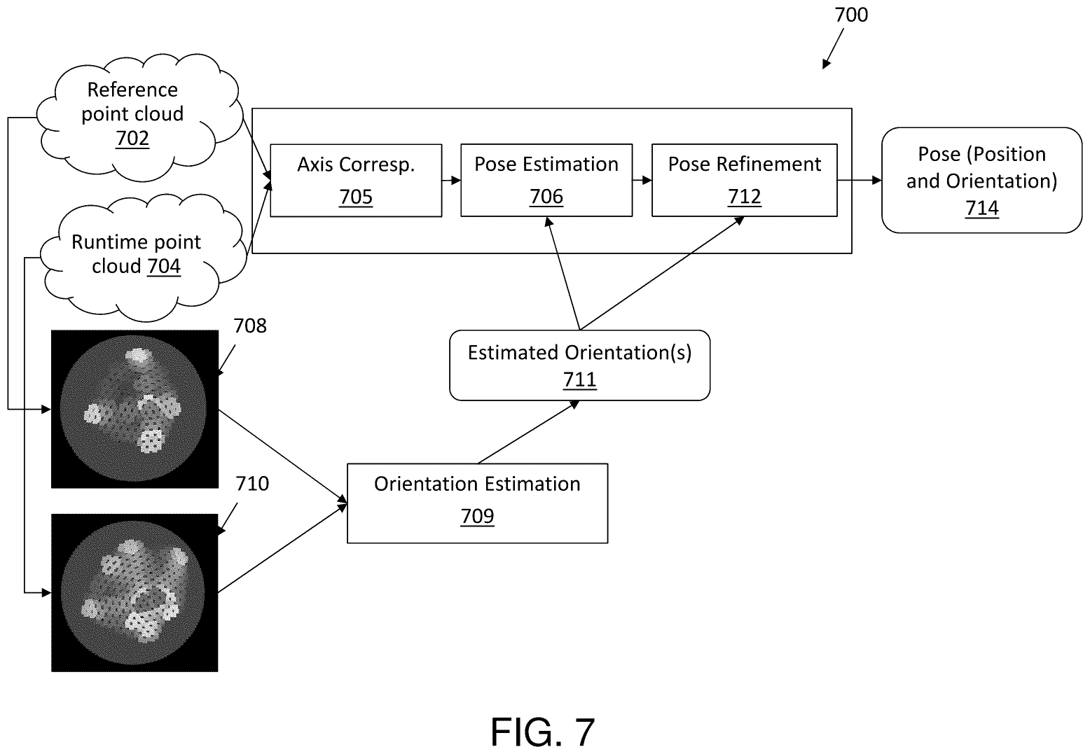

FIG. 7 is a diagram of an exemplary portion of a machine vision process 700, according to some embodiments. The machine vision process 700 can be executed via a machine vision system (e.g., the machine vision system 100 of FIG. 1). A reference 3D point cloud 702 (e.g., of a reference object, as discussed herein) and a runtime 3D point cloud 704 (e.g., obtained by imaging an object and/or scene of interest, as also discussed herein) are used as the input to the various portions of the machine vision process 700. In particular, the reference 3D point cloud 702 and the runtime 3D point cloud 704 are input to the axis correspondence process 705, which provides estimates of values of one or more degrees of freedom of pose to the pose estimation process 706. The machine vision process 700 also uses the reference 3D point cloud 702 and the runtime 3D point cloud 704 to generate second histogram 708 (e.g., a reference histogram) and first histogram 710 (e.g., a runtime histogram), respectively, as described herein (e.g., which may include one or multiple corresponding histograms, such as surface normal and/or edge direction histograms). The second histogram 708 and first histogram 710 are used as the input to the orientation estimation process 709, which generates a set of one or more estimated orientation(s) 711 of an object in the runtime 3D point cloud 704 as described herein.

As shown in FIG. 7, the estimated orientation(s) 711 can be used for the pose estimation process 706 and the pose refinement process 712. The output of the pose refinement process is a pose 714 that includes both a position and an orientation. As noted above, in some embodiments the pose estimation process 706 and the pose refinement process 712 may not know one or more orientation degrees (e.g., tilt, tilt-direction, and/or in-plane rotation) and therefore may normally be configured to check a large number of values for those degree(s). The pose estimation process 706 and/or the pose refinement process 712 can be constrained based on the estimated orientation(s) 711, such that the pose estimation process 706 and/or the pose refinement process 712 only use the associated pose value(s) from the estimated orientation(s) 711 and/or within a range of the estimated orientation(s) 711. Accordingly, the estimated orientation(s) 711 can reduce the number of candidates that are tested, thus reducing the computational burden. As another example, full pose candidates (e.g., refined by the pose refinement process 712) with an orientation that is not close to any of the estimated orientation(s) 711 can be removed from the refinement process 712. An example of an indicator of closeness can be that the overall angular distance is no more than a threshold from the estimated orientation(s) 711.

As an illustrative example, assume that the axis correspondence process 705 produces at least one, but not all, orientation values (e.g., an estimated tilt and tilt-direction, but not in-plane rotation) that is input into the pose estimation process 706. Without the estimated orientation(s) 711, the pose estimation process 706 would be left to test many values for the remaining orientation values (e.g., for in-plane rotation). But, when the estimated orientation(s) 711 are available, the remaining orientation values that must be tested as part of the pose estimation process 706 can be limited based on those in the estimated orientation(s) 711. As a further illustrative example, any estimated pose(s) from the pose estimation process 706 (which may include estimated orientations and locations) that are not within a range of the estimated orientation(s) 711 can be eliminated from refinement by the pose refinement process 712. An example of a 3D pose estimation and refinement process is described in, for example, U.S. Pat. No. 10,825,199, entitled “Methods and Apparatus for Processing Image Data for Machine Vision,” owned by Cognex Corp., and incorporated by reference herein in its entirety.

Techniques operating according to the principles described herein may be implemented in any suitable manner. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

A computing device may comprise at least one processor, a network adapter, and computer-readable storage media. A computing device may be, for example, a desktop or laptop personal computer, a personal digital assistant (PDA), a smart mobile phone, a server, or any other suitable computing device. A network adapter may be any suitable hardware and/or software to enable the computing device to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media may be adapted to store data to be processed and/or instructions to be executed by processor. The processor enables processing of data and execution of instructions. The data and instructions may be stored on the computer-readable storage media.

A computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

1. A computerized method for determining a candidate three-dimensional (3D) orientation of an object represented by a three-dimensional (3D) point cloud, the method comprising:
receiving data indicative of a 3D point cloud comprising a plurality of 3D points;
determining a first histogram for the plurality of 3D points based on geometric features determined based on the plurality of 3D points;
accessing data indicative of a second histogram of geometric features of a 3D representation of a reference object;
computing, for each of a plurality of different rotations between the first histogram and the second histogram in 3D space, a scoring metric for the associated rotation; and
determining the candidate 3D orientation based on the scoring metrics of the plurality of different rotations.

2. The method of claim 1, wherein:
the plurality of different rotations are of the second histogram in 3D space with respect to the first histogram;
the plurality of different rotations are of the first histogram in 3D space with respect to the second histogram; or
some combination thereof.

3. The method of claim 1, wherein the scoring metric comprises data indicative of a measure of match of the first histogram with a rotated version of the second histogram.

4. The method of claim 1, further comprising performing each of the plurality of different rotations in three degrees of freedom space.

5. The method of claim 1, further comprising determining the geometric features based on the plurality of 3D points, comprising estimating the geometric features of a surface of the object represented by the plurality of 3D points.

6. The method of claim 1, wherein the geometric features comprise surface normals of a surface of the object represented by the plurality of 3D points, edges of the surface, or both.

7. The method of claim 1, further comprising pre-determining the plurality of different rotations.

8. The method of claim 7, further comprising pre-determining, for each of the plurality of different rotations, correspondences between bins of the first histogram and bins of the second histogram.

9. The method of claim 8, further comprising caching only the pre-determined correspondences for bins of the second histogram that comprise a value greater than a predetermined threshold.

10. The method of claim 1, further comprising:
determining a set of the plurality of different rotations with associated scoring metrics that form a local maximum; and
determining the candidate 3D orientation based on the local maximum.

11. The method of claim 10, further comprising refining, using interpolation, the candidate 3D orientation based on the local maximum to generate a refined candidate 3D orientation.

12. The method of claim 11, wherein refining, using the interpolation, comprises fitting an elliptical paraboloid to scoring metrics of rotations of the plurality of different rotations that neighbor the local maximum.

13. The method of claim 12, wherein the refined candidate 3D orientation comprises an orientation and a scoring metric of a peak of the fitted elliptical paraboloid.

14. The method of claim 1, wherein:
the candidate 3D orientation is a first candidate 3D orientation; and
the method further comprises:
computing, based on the first histogram and the second histogram, a set of candidate 3D orientations of the object represented by the 3D data, the set of candidate 3D orientations comprising the first candidate 3D orientation;
computing, based on the set of candidate 3D orientations, (1) a location of the object represented by the 3D data and (2) a final orientation; and
determining a pose of the object comprising the location and the final orientation.

15. The method of claim 14, wherein the final orientation is from the set of possible orientations and/or within a range of the set of possible orientations.

16. The method of claim 14, wherein determining the pose of the object comprising the location and the final orientation comprises
removing pose candidates with an orientation that has an angular distance greater than a threshold from the set of possible orientations.

17. A non-transitory computer-readable media comprising instructions that, when executed by one or more processors on a computing device, are operable to cause the one or more processors to determine a candidate three-dimensional (3D) orientation of an object represented by a three-dimensional (3D) point cloud, comprising:
receiving data indicative of a 3D point cloud comprising a plurality of 3D points;
determining a first histogram for the plurality of 3D points based on geometric features determined based on the plurality of 3D points;
accessing data indicative of a second histogram of geometric features of a 3D representation of a reference object;
computing, for each of a plurality of different rotations between the first histogram and the second histogram in 3D space, a scoring metric for the associated rotation; and
determining the candidate 3D orientation based on the scoring metrics of the plurality of different rotations.

18. The non-transitory computer-readable media of claim 17, wherein the scoring metric comprises data indicative of a measure of match of the first histogram with a rotated version of the second histogram.

19. The non-transitory computer-readable media of claim 17, wherein the geometric features comprise surface normals of a surface of the object represented by the plurality of 3D points, edges of the surface, or both.

20. A system comprising a memory storing instructions, and a processor configured to execute the instructions to perform:
receiving data indicative of a 3D point cloud comprising a plurality of 3D points;
determining a first histogram for the plurality of 3D points based on geometric features determined based on the plurality of 3D points;
accessing data indicative of a second histogram of geometric features of a 3D representation of a reference object;
computing, for each of a plurality of different rotations between the first histogram and the second histogram in 3D space, a scoring metric for the associated rotation; and
determining the candidate 3D orientation based on the scoring metrics of the plurality of different rotations.
